(19) United States
(12) Patent Application Publication
(10) Pub. No.: US 2023/0380324 A1
(43) Pub. Date: Nov. 30, 2023

(54) PIVOT SYSTEM FOR A ROTATING AGRICULTURAL TOOL

(71) Applicant: CNH Industrial America LLC, New Holland, PA (US)

(72) Inventor: James L. Tetrick, Washington, IL (US)

(21) Appl. No.: 17/664,778

(22) Filed: May 24, 2022

(51) Int. Cl. A01B 71/04; A01B 63/24; A01B 71/02

(52) U.S. Cl. CPC A01B 71/04; A01B 63/24; A01B 71/02

(57) ABSTRACT

A pivot system for a rotating agricultural tool includes a bearing assembly has an inner bearing race and an outer bearing race. The pivot system also includes a shaft having a first longitudinal end and a second longitudinal end. The shaft has an angled surface extending from the first longitudinal end to the second longitudinal end. The angled surface has a plurality of points of contact. The inner bearing race contacts the plurality of points of contact to enable the bearing assembly to pivot about a transverse axis that extends perpendicularly to the longitudinal axis of the shaft.

### BACKGROUND

The present disclosure relates generally to a pivot system for a rotating agricultural tool.

To attain enhanced agricultural performance from a piece of land, a farmer typically cultivates the soil, such as through a tillage operation. Common tillage operations include plowing, harrowing, and sub-soiling. Farmers perform these tillage operations by pulling a tillage implement behind an agricultural work vehicle, such as a tractor. Depending on the crop selection and the soil conditions, a farmer may perform several tillage operations at different times to properly cultivate the land to suit the crop choice.

Certain modern farming practices include establishing a smooth, level field with small clods of soil in the fall and spring of the year. In this regard, residue is cut, sized, and mixed with soil to encourage the residue to decompose and not build up on planting/seeding machinery. To achieve such soil conditions, rolling baskets, such as crumbler reels, may be utilized to produce smaller, more uniform clod sizes and to aid in the mixing of residue. In some instances, rolling baskets are coupled to a portion of the implement frame via hangers to condition the field during each pass. However, in such instances, pressure may be applied to the hangers during operation, causing strain on the rolling baskets.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, pivot system for a rotating agricultural tool is provided. The pivot system includes a bearing assembly has an inner bearing race and an outer bearing race. The pivot system also includes a shaft having a first longitudinal end and a second longitudinal end. The shaft has an angled surface extending from the first longitudinal end to the second longitudinal end. The angled surface has a plurality of points of contact. The inner bearing race contacts the plurality of points of contact to enable the bearing assembly to pivot about a transverse axis that extends perpendicularly to the longitudinal axis of the shaft.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement, in accordance with aspects of the present disclosure;

FIG. 2 is a perspective view of an embodiment of a finishing assembly that may be employed within the agricultural implement of FIG. 1, in which the finishing assembly includes a rolling basket, in accordance with aspects of the present disclosure;

FIG. 3 is a perspective view of an embodiment of a hanger that may be coupled to the rolling basket of FIG. 2, in accordance with aspects of the present disclosure;

FIG. 4 is a cross-sectional view of the hanger of FIG. 3 having a shaft that is coupled to a bearing assembly, in accordance with aspects of the present disclosure;

FIG. 5A is a cross-sectional view of the shaft of FIG. 4, in accordance with aspects of the present disclosure;

FIG. 5B is a front view of the shaft of FIG. 4, in accordance with aspects of the present disclosure;

FIG. 5C is a perspective view of the shaft of FIG. 4, in accordance with aspects of the present disclosure;

FIG. 6A is a front view of an embodiment of a cap that may be coupled to the shaft of FIG. 4, in accordance with aspects of the present disclosure; and

FIG. 6B is a cross-sectional view of the cap of FIG. 6A, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed to a pivot system for a rolling basket of an agricultural implement and other rotating agricultural tools. In certain embodiments, the pivot system includes a shaft and a bearing. The shaft may include angled surface(s) extending along one or more axes (e.g., the centerline axis and/or transverse axis) of the shaft, such that when the bearing is coupled to the shaft, only a portion (e.g., one or more surfaces, one or more points, one or more locations, etc.) of the shaft physically contacts the bearing. The bearing may pivot between different positions between portions of the angled surface, thus resulting in different portions of the shaft contacting the bearing. Enabling the bearing to pivot may improve the longevity of the bearing by reducing wear from stacking tolerances and loads applied to the bearing.

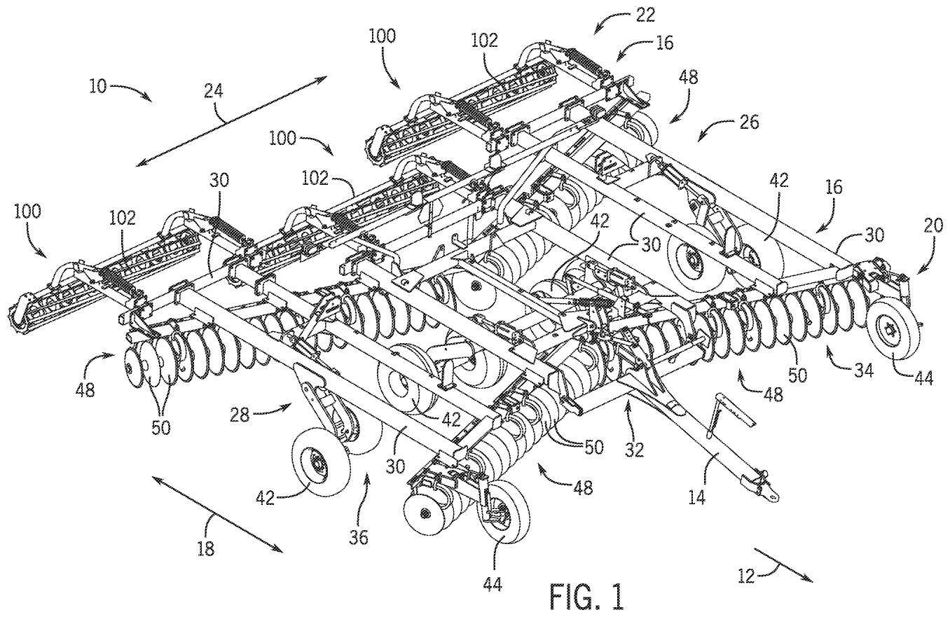

Referring now to the drawings, FIG. 1 is a perspective view of an embodiment of an agricultural implement 10. The agricultural implement 10 may be configured to be towed along a forward direction of travel 12 by a work vehicle, such as a tractor or other agricultural work vehicle. For example, the work vehicle may be coupled to the implement 10 via a hitch assembly 14 or using any other suitable attachment means. As shown, the hitch assembly 14 is coupled to a frame 16 of the implement 10 to facilitate towing the implement 10 in the direction of travel 12.

As shown, the frame 16 extends in a longitudinal direction (e.g., as indicated by arrow 18 in FIG. 1) between a forward end 20 and an aft end 22. The frame 16 also extends in a lateral direction (e.g., as indicated by arrow 24 in FIG. 1) between a first side 26 and a second side 28. In addition, the frame 16 includes multiple structural frame members 30, such as beams, bars, and/or the like, configured to support multiple components.

In certain embodiments, the frame 16 may include one or more sections. For example, in the illustrated embodiment, the frame 16 includes a main or center section 32 positioned centrally between the first and second sides 26, 28 of the frame 16. The frame 16 also includes a first wing section 34 positioned adjacent to the first side 26 of the frame 16. In addition, the frame 16 includes a second wing section 36 positioned adjacent to the second side 28 of the frame 16. The first and second wing sections 34, 36 may be pivotally coupled to the main section 32 of the frame 16. Accordingly, the first and second wing sections 34, 36 may be configured to fold up relative to the main section 32 to reduce the lateral width of the implement 10 to permit, for example, storage and transportation of the implement 10 (e.g., on a road). While the frame 16 includes three frame sections in the illustrated embodiment, in other embodiments, the frame 16 may include any suitable number of frame sections.

The agricultural implement 10 also includes wheel assemblies coupled to the frame 16 to support the frame 16 relative to the ground and to facilitate towing the implement 10 in the direction of travel 12. In certain embodiments, the agricultural implement 10 includes multiple center support wheel assemblies 42 located centrally on the frame 16 between the forward and aft ends 20, 22, with the wheel assemblies 42 being spaced apart from one another in the lateral direction 24 of the implement 10 between the first and second sides 26, 28. In addition, the implement 10 may also include forward support wheel assemblies 44 coupled to the frame 16 adjacent to the forward end 20 of the frame 16, with the wheel assemblies 44 being spaced apart from one another in the lateral direction 24 of the agricultural implement 10 between the first and second sides 26, 28. The forward support wheel assemblies 44 may be spaced apart from the center support wheel assemblies 42 in the longitudinal direction 18 of the agricultural implement 10. The agricultural implement 10 may include any suitable number and/or type of wheel assemblies in alternate embodiments.

Referring still to FIG. 1, the agricultural implement 10 includes multiple ground-engaging tools supported by the frame 16. For example, in the illustrated embodiment, the frame 16 is configured to support one or more gangs or sets 48 of disc blades 50 at the forward end 20 and/or at aft end 22. Each disc blade 50 may, for example, include both a concave side and a convex side. Furthermore, the gangs 48 of disc blades 50 may be oriented at an angle relative to the travel direction 12 to promote more effective tilling of the soil. Additionally, in the illustrated embodiment, the agricultural implement 10 includes one or more finishing assemblies 100, and the frame 16 supports the finishing assemblies 100 adjacent to the aft end 20. As will be described below, each finishing assembly 100 includes a rolling basket 102, which is configured to rotate along the soil surface to reduce clods in the soil and/or firm the soil over which the agricultural implement 10 travels.

In addition to the gangs 48 of disc blades 50 and the rolling baskets 102 of the finishing assemblies 100, the agricultural implement 10 may include any other suitable ground-engaging tools. For instance, if the agricultural implement 10 is configured as a cultivator or ripper, the agricultural implement 10 may include one or more shanks, one or more harrow tines, one or more leveling blades, other suitable ground-engaging tool(s), or a combination thereof. It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

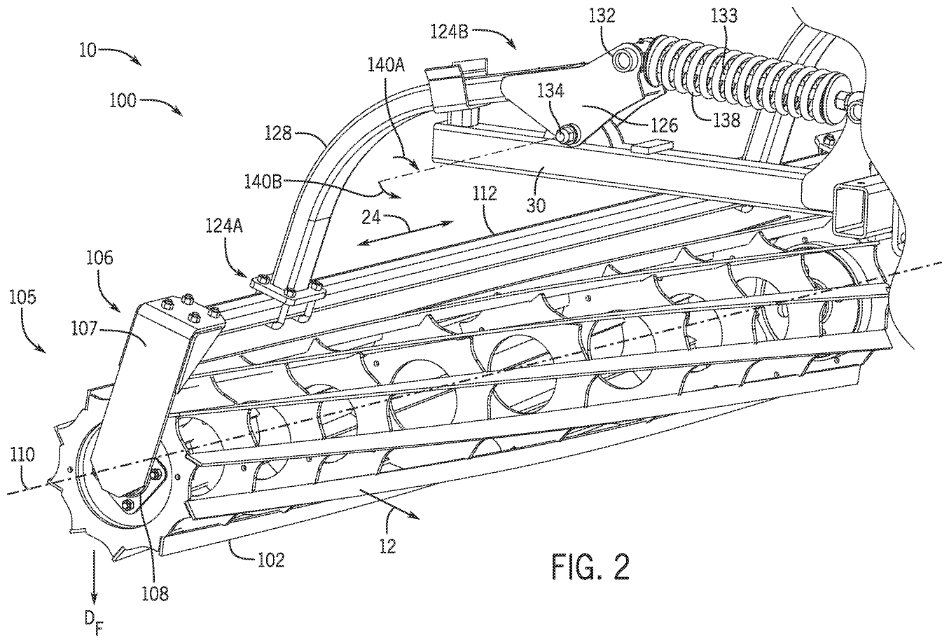

Referring now to FIG. 2, a perspective view of one embodiment of a finishing assembly (e.g., the finishing assemblies 100 shown in FIG. 1) is illustrated in accordance with aspects of the present subject matter. Specifically, FIG. 2 illustrates a perspective view of one of the finishing assemblies 100 described above with reference to FIG. 1. It should be appreciated that, for purposes of discussion, the finishing assembly 100 will be generally described with reference to the tillage implement 10 shown in FIG. 1. However, those of ordinary skill in the art will readily appreciate that the disclosed finishing assembly 100 may be utilized with any suitable agricultural implements having any other suitable implement configuration(s).

The finishing assembly 100 includes a rolling basket 102. In general, the rolling basket 102 may have any suitable configuration that enables the baskets to generally function as described herein.

In the illustrated embodiment, the finishing assembly 100 includes a basket support assembly 105 configured to support the rolling basket 102. The basket support assembly 105 includes one or more hangers 106 configured to support the rolling baskets 102 for rotation relative to the ground, such as by including a hanger 106 at each of the opposed ends of the rolling basket 102. In the illustrated embodiment, each hanger 106 has an extending arm 107. The rolling basket 102 is rotatably coupled to the extending arm 107 of the hanger 106 by a pivot system 108 (e.g., including bearing(s) and associated mounting structure(s)), such that the rolling basket 102 is rotatable about a rotational axis 110. The rolling basket 102 is supported by the hangers 106.

In the illustrated embodiment, the basket support assembly 105 further includes a toolbar 112 configured to support one or more of the hangers 106. For example, the toolbar 112 may be rigidly coupled to the hangers 106 that are coupled to the respective rolling basket 102 to support the hangers 106 relative to the ground. The toolbar 112 may, in some embodiments, support multiple hangers 106 for more than one rolling basket 102.

Additionally, in the illustrated embodiment, the basket support assembly 105 includes linkages 128. As shown in FIG. 2, each linkage 128 extends lengthwise between a first end 124A and a second end 124B. The first end 124A of each linkage 128 is fixedly coupled to the toolbar 112, and the second end 124B of the linkage 128 is fixedly coupled to a respective mounting bracket 126 of the finishing assembly 100. Each mounting bracket 126 is pivotally coupled to a respective frame member 30 of the implement frame of the agricultural implement 10 (e.g., at the aft end of the agricultural implement 10) at a pivot point 134.

Each mounting bracket 126 is pivotally coupled to a respective downforce actuator 138 at a pivot point 132. Each downforce actuator 138 (e.g., including a coil spring, a hydraulic cylinder, etc.) provides downforce to the basket support assembly 105. In some embodiments, the downforce actuator 138 may include a hydraulic or pneumatic cylinder instead of the coil spring. In the illustrated embodiment, each downforce actuator 138 includes a coil spring disposed about a rod 133. The force applied by the coil spring may be adjusted via rotation of a nut engaged with the rod 133. Each downforce actuator 138 urges the respective mounting bracket 126 to rotate in a first rotational direction 140A, thereby urging the rolling basket 102 toward the ground. As a result, the rolling basket 102 provides a downforce DF to the ground. In addition, in response to contact between the rolling basket 102 and an obstruction within the field, the rolling basket 102 may drive the brackets 126 to rotate in a second rotational direction 140B (opposite the first rotational direction 140A), thereby compressing the downforce actuators 138.

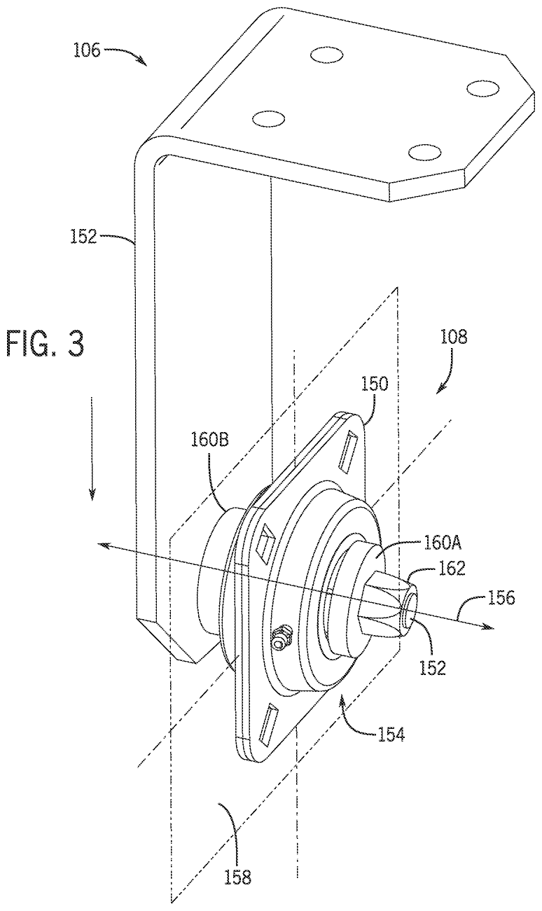

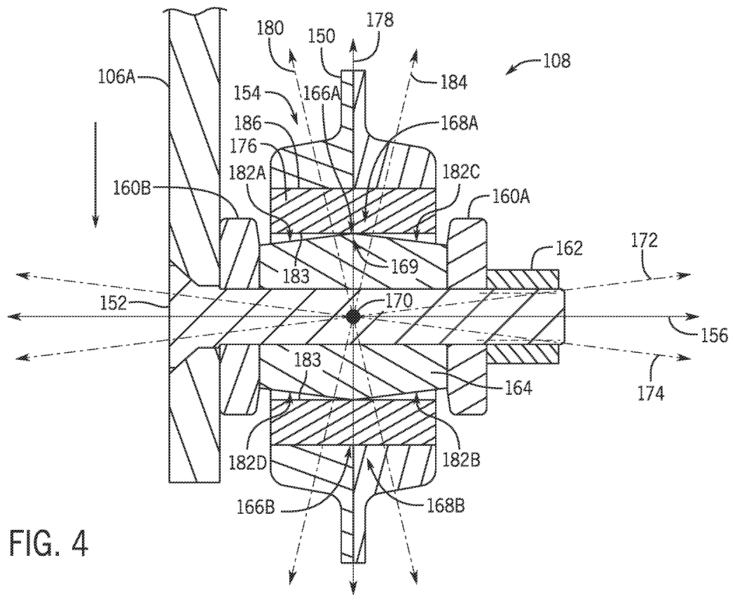

In accordance with aspects of the present subject matter, forces exerted on the rolling baskets 102 (e.g., the biasing force applied by the rolling basket downforce actuators 138, etc.) may exert a strain on components of the hangers 106 and/or the rolling baskets 102. To reduce the strain on the components of the hangers 106 and/or rolling baskets 102, at least one pivot system 108 (e.g., each pivot system 108 coupled to the rolling basket, etc.) may have a shaft with angled surface(s). The shaft is coupled to a bearing that facilitates rotation of the rolling baskets 102. To illustrate the pivot system 108, FIG. 3 and FIG. 4 show various views of an embodiment of the hanger 106 having the pivot system 108. Referring to FIG. 3, FIG. 3 is a perspective view of an embodiment of a hanger 106 that may be coupled to the rolling basket of FIG. 2. In the illustrated embodiment, the hanger 106 includes a flange 150 (e.g., square flange) that is rotatably coupled to an axle 152 via a bearing assembly 154. The flange may couple to the rolling basket (e.g., rolling basket 102 described above with respect to FIGS. 1 and 2). As described in more detail with respect to FIG. 4, the bearing assembly 154 is mechanically coupled to the axle 152 via a shaft positioned between the bearing assembly 154 and the axle 152. The flange 150 rotates about a centerline axis 156 (e.g., which may be coaxial with the axis 110 described above with respect to FIG. 2) of the axle 152 and the shaft within a median plane 158 of the flange 150 and bearing assembly 154.

In the illustrated embodiment, the shaft is disposed between two caps 160A, 160B. The pivot system 108 also includes a fastener 162 that couples to the axle 152, thereby coupling the caps 160A, 160B and the shaft 164 to the axle 152, such that movement of the shaft along the axle 152 is substantially blocked. While the shaft is disclosed herein as being separate or distinct from the axle 152, at least in some instances, the shaft and axle 152 may be the same component.

As described in more detail with respect to FIG. 4, the shaft includes angled surface(s) that may improve the longevity of certain components of the hangers 106 by enabling the flange 150 and bearing assembly 154 to pivot, thereby reducing strain on the components from loads exerted on the rolling basket. For example, the pivot system 108 may enable the rolling basket to bend without exerting a resultant moment on the bearing assembly 154 (e.g., the bearing of the bearing assembly 154) and/or the hanger 106 thereby improving the longevity of the components of the bearing assembly 154 and the hanger 106.

FIG. 4 is a cross-sectional view of the hanger 106 of FIG. 3. In the illustrated embodiment, the hanger 106 includes the flange 150, which is rotatably coupled to a shaft 164 via the bearing assembly 154. In the illustrated embodiment, the bearing assembly 154 is pivotally coupled to one or more points (e.g., portions) 166A, 166B of angled surfaces 168A, 168B of the shaft 164, respectively. The angled surface(s) of the shaft 164 enable the bearing assembly 154 and the flange 150 to pivot about a transverse axis 170 (e.g., radial axis) of the shaft 164.

In the illustrated embodiment, the shaft 164 is coupled to the axle 152, and the shaft 164 extends along a portion of the axle 152 in a direction along a longitudinal axis of the axle 152. In the illustrated embodiment, the shaft 164 is disposed between the two caps 160A, 160B, which substantially block longitudinal movement (e.g., movement along the centerline axis 156) of the shaft 154. Additionally, in some embodiments, the caps 160A, 160B may substantially block rotation of the shaft 164 about the centerline axis. In some embodiments, the shaft 164 may be coupled to the axle 152 via a welded connection, an adhesive connection, a fastener connection, a press-fit connection, another suitable connection, or a combination thereof. Additionally or alternatively, the shaft 164 may be coupled to the axle 152 by the caps 160A, 160B and the fastener 162. In some embodiments, the caps 160A, 160B may be omitted. For example, the fastener 162 may block movement of the shaft 164 or movement of the shaft 164 may be blocked when the shaft 164 is coupled to the axle 152 via a connection such as a welded connection, adhesive connection, a fastener connection, a press-fit connection, another suitable connection, or a combination thereof.

As illustrated, the angled surfaces 168A, 168B tapers along a longitudinal axis of the shaft 164. In general, the angled surface 168 is a surface forming an apex 169 (e.g., at point 166) along the shaft 164. Although two angled surfaces 168A, 168B are shown, the shaft 164 may include more or fewer angled surfaces that taper along the longitudinal axis of the shaft. In some embodiments, the shaft 164 may be a tapered cylinder having an angled surface. For example, the shaft 164 may include multiple angled surfaces 168 disposed circumferentially about the longitudinal axis. As the bearing assembly 154 and the flange 150 pivot, the bearing assembly 154 may physically contact different portions (e.g., the first portion 182A, the second portion 182B, the third portion 182C, and the fourth portion 182D) of the angled surfaces 168. Enabling the bearing assembly 154 and the flange 150 to pivot may reduce or minimize strain on the bearing assembly 154, the flange 150, and/or the shaft 164 that result from loads applied to the rolling basket 102. For example, during operation of the roller baskets, external loads applied by the rolling basket (e.g., downforce DF) may exert a resultant moment on the bearing assembly 154 (e.g., the bearing of the bearing assembly 154) and/or the hanger 106. By providing the pivot system 108, the rolling baskets 102 may move (e.g., bend) while the bearing assembly 154 may pivot to different positions, thereby improving the longevity of the components of the bearing assembly 154 and the hanger 106.

For example, bending of the rolling basket may cause the centerline axis 156 to move to the first position 172 or the second position 174. Providing the angled surface(s) 168 on the exterior of the shaft 164 enables the bearing assembly 154 to pivot about the transverse axis 170, thereby reducing strain on the axle, other components of the hanger 106, and the rolling basket. As the bearing assembly 154 pivots, the bearing assembly 154 may physically contact different portions of the angled surfaces 168. For example, with the median plane 158 of the bearing assembly 154 in the initial position, the shaft 164 contacts the bearing assembly 154 at the points 166A, 166B. If the load applied to the rolling basket causes the centerline axis 156 to move from the initial position to the first position 172, the median plane of the flange 150 may pivot to the first angular position 180. At the first angular position 180, the portions 182A, 182B of the angled surfaces 168A, 168B may contact the inner surface 183 of an inner race 176 of the bearing assembly 154. Likewise, if the load applied to the rolling basket causes the centerline axis 156 to move from the initial position to the second position 174, the median plane 158 of the flange 150 may pivot to the second angular position 184. At the second angular position 184, the portions 182C, 182D of the angled surfaces 168A, 168B may contact the inner surfaces 183 of the inner race 176 of the bearing assembly 154. As the bearing assembly 154 pivots, the inner race 176 of the bearing assembly 154 maintains contact with the shaft 164. In general, the bearing assembly 154 may pivot between portions 182 of the angled surface 168. In addition, the flange 150 may be fixedly coupled to an outer race 186 of the bearing assembly 154. Accordingly, the flange 150 may rotate about the centerline axis 156 as the bearing assembly 154 pivots. The shape of the inner race 176 may be cylindrical, or a shape complementary to the shaft, such as a hexagonal shape. With a complementary shape, the inner race and the shaft may be non-rotatably coupled to one another.

In some embodiments, an elastomer material may be disposed on the angled surfaces 168A, 168B of the shaft 164, such that the inner surfaces 183A, 183B of the inner race 176 contact the elastomer material. The elastomer material may enable the bearing assembly 154 to pivot about the transverse axis 170 and may enhance the longevity of the shaft 164.

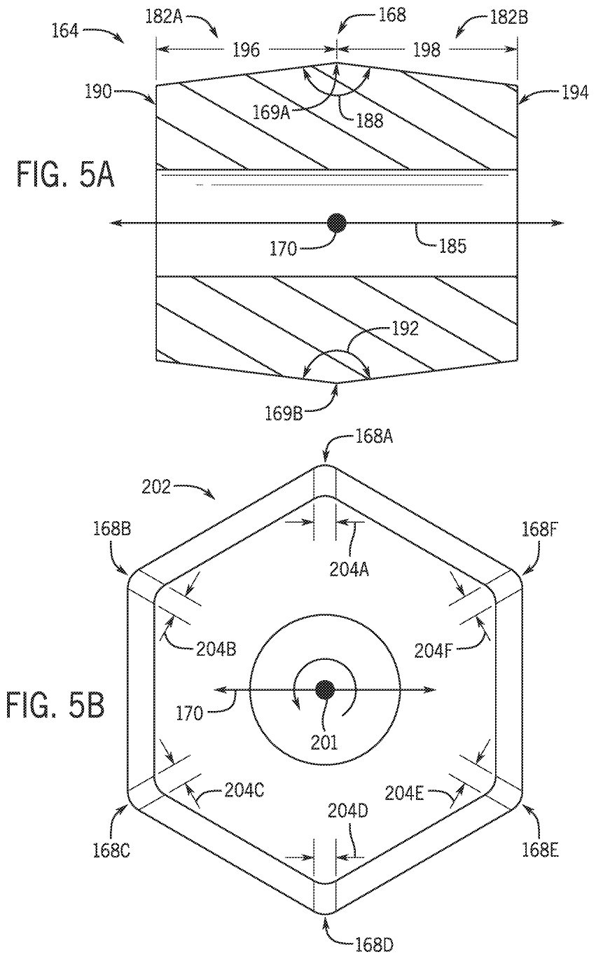

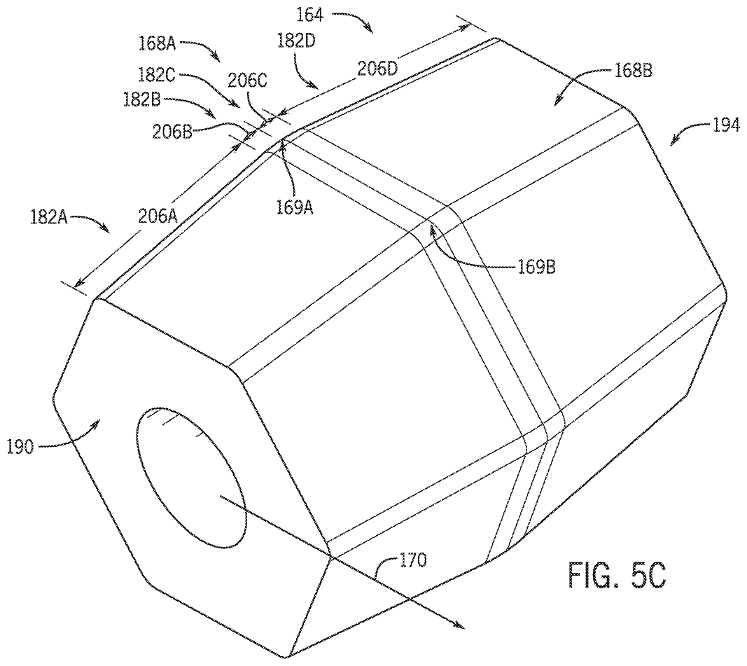

To further illustrate the angled surface of the shaft, FIGS. 5A-5C (e.g., FIG. 5A, FIG. 5B, and FIG. 5C) provide different views of the shaft 164. For example, FIG. 5A is a cross-sectional view of the shaft 164 of FIG. 4. In the illustrated embodiment, the angled surface 166 includes portions 182A, 182B (e.g., outer contact surfaces) that are sloped downwardly relative to the longitudinal axis 185 of the shaft. The bearing assembly may be pivotally coupled to the shaft 164, such that the bearing assembly is capable of pivoting about the transverse axis 170. While the illustrated embodiment of the shaft 164 includes two angled surfaces, in other embodiments, the shaft may include fewer or more angled surfaces. In the illustrated embodiment, the angled surface 166 tapers to form an apex 169A between a first portion 182A and a second portion 182 B. The apex 169A has an angle 188. The first portion 182A extends from the apex 169A towards a first longitudinal end 190. The second portion 182B extends from the apex 169A towards a second longitudinal end 194. In the illustrated embodiment, the lengths 196, 198 of the first portion 182A and the second portion 182B are substantially equal. However, in alternative embodiments, the lengths 196, 198 of the first portion 182A and the second portion 182B may be any suitable lengths (e.g., different from one another, etc.). Additionally, in the illustrated embodiment, the angle 188 of the apex 169A and the angle 192 of the apex 169B are substantially equal. However, in alternative embodiments, the angles 188, 190 may be any suitable angle (e.g., different from one another, etc.).

FIG. 5B is a front view of the shaft 164 of FIG. 4. In the illustrated embodiment, the shaft 164 includes six angled surfaces 168A, 168B, 168C, 168D, 168E, and 168F. The bearing assembly disclosed above may be pivotally coupled to the shaft 164, such that the bearing assembly is capable of pivoting about the transverse axis 170 while maintaining contact with the angled surfaces 168A, 168B, 168C, 168D, 168E, and 168F, as compared to being coupled with the entirety of an outer surface of the bearing. In the illustrated embodiment, the angled surfaces 168A, 168B, 168C, 168D, 168E, and 168F are substantially equally spaced apart from one another along a circumferential axis 202 of the shaft 164. However, in alternative embodiments, the angled surfaces 168A, 168B, 168C, 168D, 168E, and 168F may be positioned in any suitable locations along the circumferential axis 202 of the shaft. Furthermore, while the illustrated shaft 164 includes six angled surfaces 168A, 168B, 168C, 168D, 168E, and 168F, in alternative embodiments, the shaft may include more or fewer angled surfaces (e.g., 1, 2, 3, 4, 5, 6, 7, 8, or more). Moreover, in the illustrated embodiment, the angled surfaces 168A, 168B, 168C, 168D, 168E, and 168F have substantially equal radii of curvature 204A, 204B, 204C, 204D, 204E, and 204F. However, in alternative embodiments, the radii of curvature 204A, 204B, 204C, 204D, 204E, and 204F may be different from one another.

FIG. 5C is a perspective view of the shaft 164 of FIG. 4, in which the shaft has angled surfaces 168A, 168B each extending between longitudinal ends 190 and 194 to form apexes 169A, 169B. The angled surface 168A has portions 182A, 182B, 182C, and 182D having lengths 206A, 206B, 206C, and 206D, respectively. In general, a bearing (e.g., the bearing 176 discussed with respect to FIG. 4) may be pivotally coupled to the shaft 164 in FIG. 5B such that the bearing is capable of pivoting about the transverse axis 170. As the bearing pivots, it may contact portions 182A, 182B, 182C, or 182D, as compared to being coupled with the entirety of an outer surface of the bearing. In the illustrated embodiment, the portions 182A, 182D have substantially similar lengths 206A, 206D, respectively. However, in alternative embodiments, the lengths 206A, 206D of the portions 182A, 182D, respectively, may be different from one another. In the illustrated embodiment, the portions 182B, 182C have substantially similar lengths 206B, 206C, respectively. However, in alternative embodiments, the lengths 206B, 206C of the angled surfaces 206B, 206C, respectively, may be different from one another.

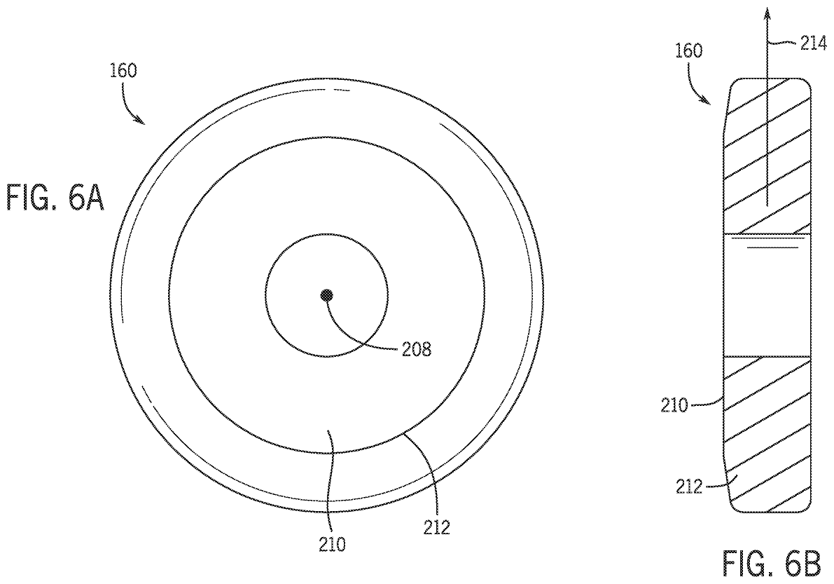

As discussed herein, the shaft 164 may be disposed between two caps 160A, 160B. FIG. 6A and FIG. 6B show an embodiment of the caps 160A, 160B. In particular, FIG. 6A is a front view of an embodiment of a cap 160 that may be coupled to the shaft of FIG. 4, and FIG. 6B is a cross-sectional view of the cap of FIG. 6A. In the illustrated embodiment, the cap 160 is radially symmetric about a centerline axis 208. Additionally, the surface 210 may include a beveled portion 212 that is further illustrated in FIG. 6B. In the illustrated embodiment, the beveled portion 212 tapers along a direction 214. However, in alternative embodiments, the surface 210 may not include a beveled portion 212, or the entire surface 210 may be beveled.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A pivot system for a rotating agricultural tool, comprising:
a bearing assembly comprising an inner bearing race and an outer bearing race; and
a shaft having a first longitudinal end and a second longitudinal end, wherein the shaft comprises an angled surface extending from the first longitudinal end to the second longitudinal end, wherein the angled surface comprises a plurality of points of contact, wherein the inner bearing race contacts the plurality of points of contact to enable the bearing assembly to pivot about a transverse axis that extends perpendicularly to the longitudinal axis of the shaft.

2. The pivot system of claim 1, wherein the plurality of points of contact comprises more than three points of contact.

3. The pivot system of claim 1, where in the plurality of points of contact are circumferentially disposed about the longitudinal axis of the shaft.

4. The pivot system of claim 1, wherein the shaft is disposed about an axle.

5. The pivot system of claim 1, wherein the transverse axis is substantially perpendicular to a centerline axis of the bearing.

6. The pivot system of claim 1, wherein the plurality of points of contact comprise an apex formed along the angled surface.

7. A pivot system for a rotating agricultural tool, comprising,
a bearing assembly comprising an inner bearing race and an outer bearing race; and
a shaft having a first longitudinal end and a second longitudinal end, wherein the shaft tapers downwardly from an apex toward the first and second longitudinal ends, and the inner bearing race contacts the apex to enable the bearing assembly to pivot about a transverse axis that extends perpendicularly to a longitudinal axis of the shaft.

8. The pivot system of claim 7, wherein the shaft comprises a first angled surface extending between the first longitudinal end and the second longitudinal end, and the shaft comprises a second angled surface extending between the first longitudinal end and the second longitudinal end.

9. The pivot system of claim 7, comprising an elastomer material disposed between the inner bearing race and the shaft.

10. The pivot system of claim 7, wherein the inner bearing race comprises a surface that is complementary to the shaft.

11. The pivot system of claim 7, wherein the shaft comprises a plurality of angled surfaces disposed circumferentially about the longitudinal axis of the shaft, and each angled surface of the plurality of angled surfaces extends from the first longitudinal end to the second longitudinal end.

12. The pivot system of claim 7, wherein a cross section of the shaft comprises more than four sides.

13. The pivot system of claim 7, wherein the shaft is disposed about an axle.

14. A hanger for a rotating agricultural tool, comprising,
an extending arm;
a pivot system coupled to the extending arm, the pivot system comprising:
a bearing assembly comprising an inner bearing race and an outer bearing race; and
a shaft having a first longitudinal end and a second longitudinal end, wherein the shaft tapers downwardly from an apex toward the first and second longitudinal ends, and the inner bearing race contacts the apex to enable the bearing assembly to pivot about a transverse axis that extends perpendicularly to a longitudinal axis of the shaft.

15. The hanger of claim 14, comprising an axle, wherein the shaft is disposed about an axle.

16. The hanger of claim 15, comprising a first cap disposed along the axle and coupled to the first longitudinal end of the shaft and a second cap coupled to the second longitudinal end of the shaft.

17. The hanger of claim 16, comprising a fastener coupled to the first cap and the axle.

18. The hanger of claim 14, comprising a rolling basket mount that extends along a direction substantially perpendicular to the centerline axis, wherein the rolling basket mount is rotatably coupled to the bearing assembly.

19. The hanger of claim 14, wherein the shaft comprises a plurality of angled surfaces disposed circumferentially about the longitudinal axis of the shaft, and each angled surface of the plurality of angled surfaces extends from the first longitudinal end to the second longitudinal end.

20. The hanger of claim 14, wherein a cross section of the shaft comprises more than four sides.
